(19) United States
(12) Patent Application Publication
(10) Pub. No.: US 2024/0217513 A1
(43) Pub. Date: Jul. 4, 2024

(54) VEHICLE CONTROL SYSTEM AND METHOD

(71) Applicant: HYUNDAI MOBIS CO., LTD., Seoul (KR)

(72) Inventor: Nam Soo KIM, Yongin-si (KR)

(73) Assignee: HYUNDAI MOBIS CO., LTD., Seoul (KR)

(21) Appl. No.: 18/519,333

(22) Filed: Nov. 27, 2023

(30) Foreign Application Priority Data
Jan. 4, 2023 (KR) 10-2023-0001402

(51) Int. Cl. B60W 30/12

(52) U.S. Cl. CPC B60W 30/12; B60W 2420/42; B60W 2520/06; B60W 2552/10; B60W 2552/53

(57) ABSTRACT

A vehicle control system and method, the method including: recognizing a driving lane ahead of a vehicle by means of a camera included in the vehicle, and determining an expected lane width of the driving lane over time; determining whether a real lane width of the driving lane increases at a time point at which the determined expected lane width increases; and when it is determined that the real lane width increases, controlling driving, based on information on a line, among both lines of the driving lane, positioned in an opposite direction of a direction in which the lane width increases.

### CROSS-REFERENCE TO RELATED APPLICATION (S)

This application is based on and claims priority under 35 U.S.C. 119 to Korean Patent Application No. 10-2023-0001402, filed on Jan. 4, 2023, in the Korean Intellectual Property Office, the disclosure of which is herein incorporated by reference in its entirety.

### 1. TECHNICAL FIELD

The present disclosure relates to a vehicle control system and method for controlling a vehicle to keep driving in a current driving lane.

### 2. BACKGROUND

An autonomous vehicle employs an advanced driver assistance system (ADAS) to free a driver from simple work, such as steering wheel and pedal manipulation during driving, and prevent accidents caused by a driver's carelessness. Therefore, people's interest therein is currently increasing.

The advanced driver assistance system includes a highway driving assist (HDA) function of assisting a vehicle to travel along the center of a driving lane, and lane following assist (KFA) and lane keeping assist (LKA) functions of assisting a vehicle not to deviate from the lines of a driving lane. When such functions are performed, a vehicle may recognize the lines of a driving lane, in which the vehicle is currently driving, by using a front camera included in the vehicle, and perform steering control along the recognized Therefore, steering control lines of the driving lane performed by these kinds of assistance functions requires precise recognition of lines.

However, when steering control is performed using only curvature information of a line of a driving lane, this may be problematic in that lines are mis-recognized due to diversity of a driving road environment in which a vehicle is driving, and steering is mis-controlled. For example, if there is a stretch diverged or expanded from a driving lane in which a vehicle is driving, when the vehicle enters the stretch, the vehicle mis-recognizes a line of the diverged or expanded stretch as a line of the driving lane, and thus steering to the stretch may be performed.

The foregoing described as the background is intended merely to aid in the understanding of the background of the present disclosure, and is not intended to mean that the present disclosure falls within the purview of the related art already known to those skilled in the art.

### SUMMARY

The present disclosure has been made to solve such a problem, and is to provide a vehicle control system and method by which whether the lane width of a lane in which a vehicle is driving increases is determined, and driving of the vehicle is controlled on the basis of the determination.

The technical subjects pursued in the present disclosure may not be limited to the above-mentioned technical subjects, and other technical subjects which are not mentioned may be clearly understood, through the following descriptions, by those skilled in the art to which the present disclosure pertains.

In accordance with an aspect, a vehicle control method according to the present disclosure may include: recognizing, by a controller, a driving lane ahead of a vehicle by utilizing a camera included in the vehicle, and determining, by the controller, an expected lane width of the driving lane over time; determining, by the controller, whether a real lane width of the driving lane increases at a time point at which the determined expected lane width increases; and controlling driving, by the controller and in response to the determination that the real lane width is increasing, based on information on a line, wherein the line is one among two lines of the driving lane and positioned opposite a side of the driving lane in which the lane width increases.

For example, the determining of the expected lane width may include: recognizing, by the controller, the driving lane ahead of the vehicle by utilizing image information obtained by the camera; and determining, by the controller, an expected lane width of the driving lane, based on information included in the driving lane recognized by the camera.

For example, the determining of the expected lane width may further include determining, by the controller, an expected lane width of a driving lane recognized by the camera, based on a longitudinal distance of the vehicle and at least one piece of information among an offset, a heading angle, a curvature, and a curvature derivative value of the line.

For example, the determining of whether the real lane width increases may include: determining, by the controller, a real lane width of the driving lane at a time point at which the expected lane width increases; and determining, by the controller, whether the determined real lane width increases within a pre-configured reference time from the time point.

For example, the determining of whether the real lane width increases may include: determining, by the controller, an increased amount of the expected lane width in a time interval in which the expected lane width increases; determining, by the controller, a changed amount of the real lane width of the driving lane in the time interval; and determining, by the controller, whether the real lane width increases, based on the changed amount of the real lane width and the increased amount of the expected lane width.

For example, the controlling of the driving may include determining, by the controller, that the vehicle has entered a stretch in which the driving lane includes at least one lane among a diverged lane and an expanded lane in response to the determination that the real lane width is increasing.

For example, the controlling of the driving may further include: in response to the vehicle entering the stretch, generating, by the controller, driving control information of the vehicle, based on information of the line; and reflecting, by the controller, a pre-configured correction value on the generated driving control information and outputting the driving control information.

For example, the generating of the driving control information may include generating, by the controller, driving control information of the vehicle, based on at least one piece of information among an offset, a heading angle, a curvature, and a curvature derivative value of the line.

For example, the controlling of the driving may include: determining, by the controller and in response to the determination that the real lane width is increasing, whether the driving lane is an outermost lane; and determining, by the controller and in response to the driving lane being the outermost lane, that the vehicle has entered a stretch in which the driving lane includes at least one lane among a diverged lane and an expanded lane.

For example, the determining of whether the driving lane is the outermost lane may include: collecting, by the controller in response to the determination that the real lane width is increasing, at least one piece of information among information on the two lines of the driving lane, and information relating to existence or absence of a road edge with respect to both sides of the driving lane; and determining, by the controller, whether the driving lane is the outermost lane, by utilizing the collected at least one piece of information.

In addition, in accordance with the above aspect, a vehicle control system according to the present disclosure may include: a camera configured be in a vehicle and to capture an image of a foreground of the vehicle; and a controller configured to: recognize a driving lane, based on an image captured by the camera, determine an expected lane width of the driving lane over time, determine whether a real lane width of the driving lane increases at a time point at which the determined expected lane width increases, and control driving, based on information on a line, when it is determined that the real lane width increases, wherein the line is one among two lines of the driving lane and positioned opposite a side of the driving lane in which the lane width increases.

For example, the camera may be configured to collect image information obtained by capturing the image of the foreground of the vehicle, and the controller is further configured to recognize the driving lane in the image information, and determine an expected lane width of the driving lane, based on information related to the recognized driving lane.

For example, the controller may be configured to determine an expected lane width of a driving lane recognized by the camera, based on a longitudinal distance of the vehicle and at least one piece of information among an offset, a heading angle, a curvature, and a curvature derivative value of the line.

For example, the controller may be further configured to: determine a real lane width of the driving lane at a time point at which the expected lane width increases, and determine whether the determined real lane width increases within a pre-configured reference time from the time point.

For example, the controller may be further configured to: determine an increased amount of the expected lane width in a time interval in which the expected lane width increases, determine a changed amount of the real lane width of the driving lane in the time interval, and determine whether the real lane width increases, based on the changed amount of the real lane width and the increased amount of the expected lane width.

For example, the controller may be further configured to determine that the vehicle has entered a stretch in which the driving lane includes at least one lane among a diverged lane and an expanded lane, when it is determined that the real lane width increases.

For example, the controller may be further configured to, when the vehicle enters the stretch, generate driving control information of the vehicle, based on information of the line, and reflect a pre-configured correction value on the generated driving control information and output the driving control information.

For example, the controller may be configured to, when the vehicle enters the stretch, generate driving control information of the vehicle, based on at least one piece of information among an offset, a heading angle, a curvature, and a curvature derivative value of the line.

For example, the controller may be further configured to: determine whether the driving lane is an outermost lane when it is determined that the real lane width increases, and determine that the vehicle has entered a stretch in which the driving lane includes at least one lane among a diverged lane and an expanded lane when the driving lane is the outermost lane.

For example, the controller may be further configured to, when it is determined that the real lane width increases, collect at least one piece of information among information on the two lines of the driving lane, and information relating to existence or absence of a road edge with respect to both sides of the driving lane, and determine whether the driving lane is the outermost lane, by using the collected at least one piece of information.

According to a vehicle control system and method of the present disclosure, even when the lane width of a driving lane, in which a vehicle is driving, increases, a line positioned opposite to a side at which the lane width increases is recognized and driving of the vehicle is controlled, thereby preventing mis-controlling of lane following assist (LFA), lane keeping assist (LKA), and highway driving assist (HDA) functions which serve as transverse control in an advanced driver assistance system.

Advantageous effects obtainable from the present disclosure may not be limited to the above-mentioned effects, and other effects which are not mentioned may be clearly understood, through the following descriptions, by those skilled in the art to which the present disclosure pertains.

### BRIEF DESCRIPTION OF THE DRAWINGS

FIG. 1 is a block diagram illustrating a configuration of a vehicle control system according to an embodiment of the present disclosure;

FIG. 2 is a diagram illustrating control of a vehicle having entered a stretch in which a lane width increases, according to an embodiment of the present disclosure; and

FIG. 3 is a flowchart of a vehicle control method according to an embodiment of the present disclosure.

### DETAILED DESCRIPTION OF THE EXEMPLARY EMBODIMENTS

In describing embodiments disclosed in the present specification, when the detailed description of the relevant known technology is determined to unnecessarily obscure the gist of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

Hereinafter, embodiments disclosed in the present specification will be described in detail with reference to the accompanying drawings, and the same or similar elements are given the same and similar reference numerals, so duplicate descriptions thereof will be omitted.

A unit or a control unit included in the name “control unit” is merely a term widely used for naming a controller configured to control a specific function of a vehicle, but does not mean a generic function unit. For example, the controller may include a communication device configured to communicate with a sensor or another control unit, a memory configured to store an operation system, a logic command, or input/output information, and at least one processor configured to perform determination, calculation, decision or the like which are required for responsible function controlling.

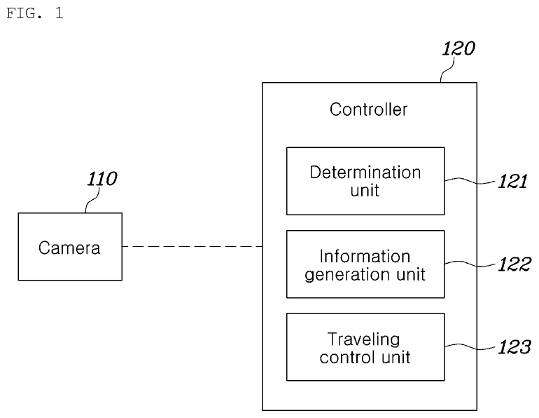

First, referring to FIG. 1, a configuration of a vehicle control system according to an embodiment of the present disclosure is described.

FIG. 1 is a block diagram illustrating a configuration of a vehicle control system according to an embodiment of the present disclosure.

Referring to FIG. 1, a vehicle control system according to an embodiment of the present disclosure may include a camera 110 and a controller 120. FIG. 1 shows mainly elements related to an embodiment of the present disclosure, and thus it is obvious that fewer or more elements may be included when a real vehicle control system is implemented.

Hereinafter, each element will be described.

The camera 110 is an image capturing device mounted at a vehicle, and may be at least one camera among a front camera, a side camera, and a rear camera according to the position in which the camera is mounted. The camera 110 according to an embodiment of the present disclosure is assumed as a front camera mounted at a front of the vehicle. The camera 110 may be mounted at the front of the vehicle to capture an image of the foreground of the vehicle. In addition, multiple cameras 110 may be arranged at the front of the vehicle, and an image of the foreground of the vehicle may be captured by means of the multiple cameras. The camera 110 may collect image information obtained by capturing an image of the foreground of the vehicle, and provide the collected information to the controller 120.

The controller 120 may recognize at least one piece of information among traffic information and road information, the traffic and roads of which are positioned ahead of the vehicle, based on the image information obtained by the camera 110. For example, the controller 120 may recognize a driving lane ahead of the vehicle, in which the vehicle is driving. Thereafter, the controller 120 may control driving of the vehicle, based on information on the recognized driving lane. An aspect of the present disclosure is to, even in a case of occurrence of a change, such as increasing of the lane width of a driving lane in which a vehicle is driving, keep controlling the vehicle to travel in the current driving lane. Therefore, the controller 120 may determine an expected lane width of the driving lane over time, determine whether a real lane width of the driving lane increases at a time point at which the determined expected lane width increases, and when it is determined that the real lane width increases, control driving, based on information on a line, among both lines of the driving lane, positioned in an opposite direction of a direction in which the lane width increases. To this end, the controller 120 may include a determination unit 121, an information generation unit 122, and a driving control unit 123. Hereinafter, each element will be described.

The determination unit 121 may recognize a driving lane in image information provided from the camera 110, and determine an expected lane width of the driving lane, based on information related to the recognized driving lane. Specifically, the determination unit 121 may determine an expected lane width of the driving lane, based on a longitudinal distance of the vehicle and at least one piece of information among an offset, a heading angle, a curvature, and a curvature derivative value of a line of the driving lane in information related to the recognized driving lane.

For example, the determination unit 121 may determine an expected lane width through a line equation, based on a longitudinal distance of the vehicle and an offset, a heading angle, a curvature, and a curvature derivative value of a line of the driving lane. The determination unit 121 may determine an expected lane width through a line equation as Equation 1 below.

$$Y = α + β X + γ {X}^{2} + δ {X}^{3} \qquad [ Equation 1 ]$$

In Equation 1, X may denote a longitudinal distance of the vehicle, and Y may denote the distance from the vehicle to the left line or the right line. α may indicate an offset of the line, β may indicate a heading angle, γ may indicate the curvature of the line, δ may indicate the curvature derivative value of the line. In addition, the determination unit 121 may apply the curvature and the curvature derivative value of the line in consideration of a correction factor.

The determination unit 121 may determine an expected lane width over time through the described line equation, based on information related to a driving lane. That is, the determination unit 121 may determine an expected lane width that is expected over time with respect to a current location of the vehicle. For example, the expected lane width may be a value obtained by adding the distance from the vehicle to the left line and the distance from the vehicle to the right line, which are determined through Equation 1 described above, respectively.

As time passes, an offset, a heading angle, a curvature, and a curvature derivative value of a line of a driving lane in which the vehicle is driving and the longitudinal distance of the vehicle may change. Therefore, the expected lane width may be determined based on an offset, a heading angle, a curvature, and a curvature derivative value of a line, and the longitudinal distance of the vehicle which are obtained in consideration of a change over time. For example, an offset, a heading angle, a curvature, and a curvature derivative value of a driving lane line which are obtained in consideration of a change over time may be determined through Equation 2 below.

$${α}_{k + 1} = {α}_{k} + {β}_{k} Δ X + {γ}_{k} Δ {X}^{2} + {δ}_{k} Δ {X}^{3} - Δ Y \qquad [ Equation 2 ]$$

$${β}_{k + 1} = {β}_{k} + 2 {γ}_{k} Δ X + 3 {δ}_{k} Δ {X}^{2} + Δθ$$

$${γ}_{k + 1} = {γ}_{k} + 3 {δ}_{k} Δ X$$

$${δ}_{k + 1} = {δ}_{k}$$

Here, αₖ, βₖ, γₖ, and ok may denote an offset, a heading angle, a curvature, and a curvature derivative value of a line at a random time of k seconds, and αₖ₊₁, βₖ₊₁, γₖ₊₁, and δₖ₊₁ may denote an offset, a heading angle, a curvature, and a curvature derivative value of a line at a random time of (k+1) seconds. ΔX, ΔY, and Δθ may be determined through Equation 3 below.

$$Δ X = V Δ T cos ( θ + Δθ ) \qquad [ Equation 3 ]$$

$$Δ Y = V Δ T sin ( θ + Δθ )$$

$$Δθ = Yawrate Δ T$$

Here, ΔX may denote the longitudinal displacement of the vehicle for ΔT, ΔY may denote the transverse displacement of the vehicle for ΔT, and Δθ may denote the angle displacement in yaw of the pose of the vehicle for ΔT.

Therefore, the determination unit 121 may determine an expected lane width of a driving lane in which the vehicle is driving, over time through line equations including Equations 1 to 3. However, this is an example, and it is obvious that a method of determining an expected lane width of a driving lane is not limited to the method described above. For example, when an expected lane width of a driving lane is determined, information other than the above information of a line may be used, and the expected lane width may be determined through methods other than the line equations described above.

Furthermore, the determination unit 121 may determine whether there is a time point at which a determined expected lane width increases, and when there is a time point at which the expected lane width increases, may determine a real lane width of the driving lane at the time point at which the expected lane width increases. If it is determined using only an expected lane width that the lane width of a driving lane in which the vehicle is driving increases, when line mis-recognition using the camera 110 occurs, the expected lane width may be incorrectly determined as increasing. Therefore, in order to prevent this problem, the determination unit 121 may determine a real lane width when an expected lane width increases, to determine whether the real lane width also increases. For example, the determination unit 121 may determine a real lane width when an expected lane width increases, and determine whether the determined real lane width increases within a pre-configured reference time from a time point at which the expected lane width increases.

As another example, the determination unit 121 may identify, in data of an expected lane width determined over time, a time interval in which the expected lane width increases, and determine an increased amount of the expected lane width in the time interval. Thereafter, the determination unit 121 may determine a changed amount of a real lane width of the driving lane in the time interval, and determine whether the real lane width increases, based on the changed amount of the real lane width and a changed amount of the expected lane width.

When it is determined that the real lane width also increases at a time point at which the expected lane width increases, the determination unit 121 may determine that the vehicle has entered a stretch in which the driving lane in which the vehicle is driving expands. For example, when it is determined that an expected lane width and a real lane width increases, the determination unit 121 may determine that the vehicle has entered a stretch in which there is at least one lane among a diverged lane and an expanded lane of the driving lane in which the vehicle is driving.

In addition, when it is determined that the real lane width also increases at a time point at which the expected lane width increases, the determination unit 121 determine whether the driving lane in which the vehicle is driving is the outermost lane. When it is determined that the real lane width increases, the determination unit 121 may collect at least one piece of information among information on both lines of the driving lane, and information relating to existence or absence of a road edge with respect to both sides of the driving lane. Thereafter, the determination unit 121 may determine whether the driving lane in which the vehicle is driving is the outermost lane, by using the collected at least one piece of information. For example, the determination unit 121 may collect information relating to existence or absence of a road edge with respect to both sides of the driving lane, and when a road edge exists at one side among both sides of the driving lane, may determine that the driving lane in which the vehicle is currently driving is the outermost lane. In addition, the determination unit 121 may collect lane information including the shapes and colors of both lines of the driving lane, and when one line of both lines of the driving lane is a line configured by a single unbroken line indicating lane change being impossible, a line configured by double lines, or a line configured by a yellow unbroken line, may determine that the driving lane in which the vehicle is currently driving is the outermost lane.

When the driving lane in which the vehicle is driving is the outermost lane, the determination unit 121 may determine that the vehicle has entered a stretch in which there is at least one lane among a diverged lane and an expanded lane of the driving lane.

Meanwhile, when the driving lane is a single one-way lane, road edges may exist at both sides of the driving lane, or both lines of the driving lane may be lines indicating lane change being impossible. Accordingly, the determination unit 121 may make mis-determination when determining whether a lane is the outermost lane. Therefore, when the driving lane is a single one-way lane, the determination unit 121 may determine which side, among both sides of the driving lane, to which an expected lane width and a real lane width increase more, based on the driving lane. Thereafter, the determination unit 121 may determine that at least one lane among a diverged lane and an expanded lane exists at a side to which the expected lane width and the real lane width increase more, and determine that the vehicle has entered a stretch in which there is at least one lane among the diverged lane and the expanded lane of the driving lane.

When it is determined that the vehicle has entered a stretch in which there is at least one lane among the diverged lane and the expanded lane of the driving lane, the determination unit 121 may transfer a result of the determination to the information generation unit 122.

When it is determined that the vehicle has entered the stretch, the information generation unit 122 may generate driving control information of the vehicle, based on information of a line, among both lines of the driving lane, existing opposite to a side at which there is at least one lane among the diverged lane and the expanded lane. For example, the information generation unit 122 may generate driving control information of the vehicle, based on at least one piece of information among the offset, a heading angle, a curvature, and a curvature derivative value of a line, among both lines of the driving lane, existing opposite to a side at which there is at least one lane among the diverged lane and the expanded lane. However, this is an example, and it is obvious that various information other than the above information may be used to generate driving control information of a vehicle.

The information generation unit 122 may output the generated driving control information of the vehicle to the driving control unit 123. When the information generation unit 122 outputs the generated driving control information, the driving control information of the vehicle generated by the information generation unit 122 may differ from driving control information of the vehicle based on information of a driving lane line previously recognized by the camera 110, and this difference may make control of vehicle driving unstable. Therefore, before outputting the generated driving control information of the vehicle, the information generation unit 122 may reflect, on the driving control information, a correction value considering a change rate of the driving control information and then output the driving control information. For example, the correction value may be a value configured by considering an upper limit value of a change rate of driving control information in order to prevent a rapid change between existing driving control information and generated driving control information. However, this is an example, and it is obvious that the disclosure is not necessarily limited thereto.

The driving control unit 123 may control driving of the vehicle, based on driving control information of the vehicle output from the information generation unit 122. For example, the driving control unit 123 may control a steering device included in the vehicle, based on the output driving control information, such that the vehicle does not travel to the side at which there is at least one lane among the diverged lane and the expanded lane, and travels in the driving lane where the vehicle is originally driving.

Meanwhile, in implementation of the controller 120 according to an embodiment of the present disclosure, the controller 120 may be implemented as one function of an advanced driver assistance system (ADAS) controller controlling an ADAS. However, this is an example, and the disclosure is not necessarily limited thereto. For example, the controller 120 may be implemented as a separate controller different from the ADAS controller, or may be implemented such that the functions thereof are disposed into two or more different controllers.

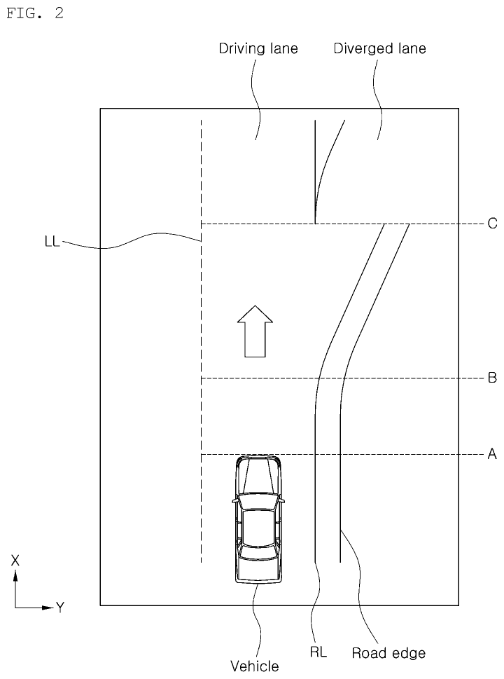

Hereinafter, a vehicle to which a vehicle control system described above has been applied will be described with reference to FIG. 2.

FIG. 2 is a diagram illustrating control of a vehicle having entered a stretch in which a lane width increases, according to an embodiment of the present disclosure.

Referring to FIG. 2, a vehicle is illustrated as moving in an X direction along a current driving lane. The vehicle illustrated in FIG. 2 may include a vehicle control system described with reference to FIG. 1.

While the vehicle is driving in the driving lane, when the vehicle reaches point A, the vehicle may determine an expected lane width over time. Thereafter, if it is determined that the expected lane width increases at point B, when the vehicle reaches point B during driving, the vehicle may determine whether a real lane width increases.

If the real lane width increases when the vehicle reaches point B, the vehicle may collect information on both lines of the driving lane in which the vehicle is driving, and information relating to existence or absence of a road edge with respect to both sides of the driving lane. When a line (RL) positioned at the right side among both sides of the driving lane in which the vehicle is driving is determined as an unbroken line indicating lane change being impossible, or when a road edge exists at the right side among both sides of the driving lane, the vehicle may determine that the driving lane in which the vehicle is currently driving is the outermost lane.

When the expected lane width and the real lane width increase at point B, and the driving lane in which the vehicle is driving is the outermost lane, the vehicle may determine that the vehicle has entered a stretch of the driving lane in which there is at least one lane among a diverged lane and an expanded lane. FIG. 2 is used to describe an example in which a diverged lane exists, but the same application to an expanded lane is obviously possible.

When a diverged lane exists at the right side in the driving lane of the vehicle, the diverged lane may be mis-recognized as the existing driving lane, and thus driving of the vehicle may be wrongly controlled. Therefore, when a diverged lane exists, the vehicle may control driving thereof, based on information of a line LL existing opposite to the line RL, among both lines of the driving lane, at which the diverged lane exists. In other words, when the vehicle enters a stretch in which a diverged lane exists, the vehicle may recognize a line LL, which faces, in a horizontal direction (Y direction), the line RL, among both lines of the driving lane, at which the diverged lane exists, and control driving of the vehicle, based on information of the line LL. If the vehicle passes point C, the vehicle becomes out of the stretch in which the diverged lane exists in the driving lane, and thus the vehicle may perform a previous driving control scheme again.

That is, while driving the driving lane, when the vehicle enters a stretch (stretch between point B and point C) in which a diverged lane exists, the vehicle may only recognize, rather than the line RL connecting to the diverged lane, only the line LL which is opposite to the line RL and faces same in the horizontal direction, and control driving of the vehicle, based on information of the line LL. Therefore, even when the vehicle enters a stretch in which a diverged lane exists, a line of the diverged lane is not mis-recognized and a line of a driving lane in the vehicle is driving is recognized, whereby malfunction of vehicle driving control can be prevented and driving stability of the vehicle can be improved.

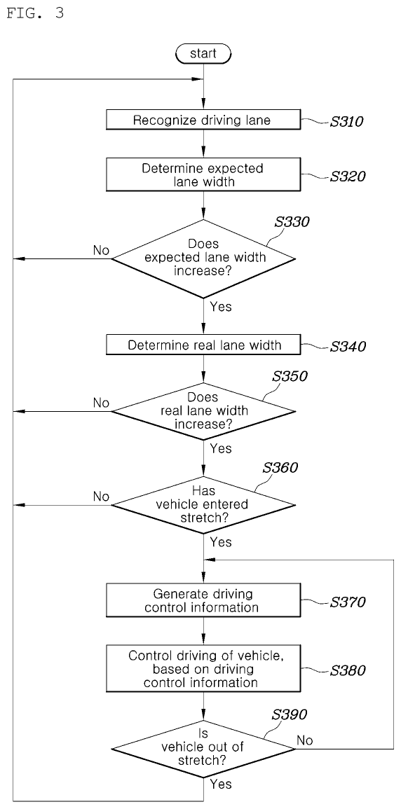

Hereinafter, a vehicle control method according to an embodiment will be described with reference to FIG. 3, based on a configuration of a vehicle control system described above with reference to FIG. 1.

FIG. 3 is a flowchart of a vehicle control method according to an embodiment of the present disclosure.

Referring to FIG. 3, an image of the foreground of a vehicle may be captured by means of the camera 110 included in the vehicle, and the controller 120 may recognize a driving lane in which the vehicle is currently driving, based on image information obtained by the camera 110 (operation S310), and may determine an expected lane width of the driving lane, based on recognized information (operation S320).

In determination of the expected lane width, when there is a time point at which the expected lane width increases (Yes of operation S330), the controller 120 may determine a real lane width at the time point at which the expected lane width increases (operation S340). When the real lane width increases at the time point at which the expected lane width increases (Yes of operation S350), the controller 120 may determine, based on whether the driving lane in which the vehicle is driving is the outermost lane, whether the vehicle has entered a stretch in which there is at least one lane among a diverged lane and an expanded lane (operation S360).

If the real lane width does not increase at the time point at which the expected lane width increases (No of operation S350), the controller 120 may defer a process of determining whether the vehicle has entered the stretch in which there is at least one lane among the diverged lane and the expanded lane. In addition, even though the real lane width increases at the time point at which the expected lane width increases (Yes of operation S350), when the driving lane in which the vehicle is driving is not the outermost lane, or recognition of both lines of the driving lane fails, the controller 120 may determine that the vehicle has not entered the stretch in which there is at least one lane among the diverged lane and the expanded lane (No of operation S360).

When the vehicle has entered the stretch in which there is at least one lane among the diverged lane and the expanded lane (Yes of operation S360), the controller 120 may recognize a line, among both lines of the driving lane, existing opposite to a side at which there is at least one lane among the diverged lane and the expanded lane. The controller 120 may generate driving control information of the vehicle, based on information of the recognized line (operation S370). The controller 120 may control driving of the vehicle, based on the generated driving control information, while driving in the stretch in which there is at least one lane among the diverged lane and the expanded lane (operation S380).

Thereafter, the controller 120 may determine whether the vehicle is out of the stretch in which there is at least one lane among the diverged lane and the expanded lane (operation S390). For example, the controller 120 may periodically measure a lane width, and when the lane width has been reduced to be similar to the lane width before the vehicle enters the stretch in which there is at least one lane among the diverged lane and the expanded lane, may determine that the vehicle is out of the stretch in which there is at least one lane among the diverged lane and the expanded lane (Yes of operation S390), and terminate control. In addition, when a longitudinal driving distance of the vehicle exceeds a pre-configured reference distance, the controller 120 may determine that the vehicle is out of the stretch in which there is at least one lane among the diverged lane and the expanded lane (Yes of operation S390). The controller 120 may perform corresponding control again, based on the driving lane recognized by the camera 110, or may terminate control.

Meanwhile, when the vehicle is still driving in the corresponding stretch without being out of the stretch in which there is at least one lane among the diverged lane and the expanded lane (No of operation S390), the controller 120 may continuously perform control based on control information of the vehicle.

As described above, according to the present disclosure, even when the lane width of a driving lane in which a vehicle is driving increases, a line positioned opposite to a side at which the lane width increases is recognized and driving of the vehicle is controlled, whereby vehicle driving mis-control caused by lane width increment can be prevented, and stability of vehicle driving control can be ensured.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Further, the above detailed description should not be construed in a limitative sense, but should be considered in an illustrative sense in all aspects. The scope of the present disclosure should not be determined by reasonable interpretation of the appended claims, and all changes and modifications within the equivalent scope of the present disclosure fall within the scope of the present disclosure.

What is claimed is:

1. A vehicle control method comprising:
recognizing, by a controller, a driving lane ahead of a vehicle by utilizing a camera included in the vehicle, and determining, by the controller, an expected lane width of the driving lane over time;
determining, by the controller, whether a real lane width of the driving lane increases at a time point at which the determined expected lane width increases; and
controlling driving, by the controller and in response to the determination that the real lane width is increasing, based on information on a line, wherein the line is one among two lines of the driving lane and positioned opposite a side of the driving lane in which the lane width increases.

2. The vehicle control method of claim 1, wherein the determining of the expected lane width comprises:
recognizing, by the controller, the driving lane ahead of the vehicle by utilizing image information obtained by the camera; and
determining, by the controller, an expected lane width of the driving lane, based on information included in the recognized driving lane.

3. The vehicle control method of claim 2, wherein the determining of the expected lane width comprises determining, by the controller, an expected lane width of a driving lane recognized by the camera, based on a longitudinal distance of the vehicle and at least one information among an offset, a heading angle, a curvature, and a curvature derivative value of the line.

4. The vehicle control method of claim 1, wherein the determining of whether the real lane width increases comprises:
determining, by the controller, a real lane width of the driving lane at a time point at which the expected lane width increases; and
determining, by the controller, whether the determined real lane width increases within a pre-configured reference time from the time point.

5. The vehicle control method of claim 1, wherein the determining of whether the real lane width increases comprises:
determining, by the controller, an increased amount of the expected lane width in a time interval in which the expected lane width increases;
determining, by the controller, a changed amount of the real lane width of the driving lane in the time interval; and
determining, by the controller, whether the real lane width increases, based on the changed amount of the real lane width and the increased amount of the expected lane width.

6. The vehicle control method of claim 1, wherein the controlling of the driving comprises determining, by the controller, that the vehicle has entered a stretch in which the driving lane includes at least one lane among a diverged lane and an expanded lane in response to the determination that the real lane width is increasing.

7. The vehicle control method of claim 6, wherein the controlling of the driving comprises:
in response to the vehicle entering the stretch, generating, by the controller, driving control information of the vehicle, based on information of the line; and
reflecting, by the controller, a pre-configured correction value on the generated driving control information and outputting the driving control information.

8. The vehicle control method of claim 7, wherein the generating of the driving control information comprises generating, by the controller, driving control information of the vehicle, based on at least one information among an offset, a heading angle, a curvature, and a curvature derivative value of the line.

9. The vehicle control method of claim 1, wherein the controlling of the driving comprises:
determining, by the controller and in response to the determination that the real lane width is increasing, whether the driving lane is an outermost lane; and
determining, by the controller and in response to the driving lane being the outermost lane, that the vehicle has entered a stretch in which the driving lane includes at least one lane among a diverged lane and an expanded lane.

10. The vehicle control method of claim 9, wherein the determining of whether the driving lane is the outermost lane comprises:
collecting, by the controller and in response to the determination that the real lane width is increasing, at least one piece of information among information on the two lines of the driving lane, and information relating to existence or absence of a road edge with respect to both sides of the driving lane; and
determining, by the controller, whether the driving lane is an outermost lane, by utilizing the collected at least one piece of information.

11. A vehicle control system comprising:
a camera configured to be in a vehicle and to capture an image of a foreground of the vehicle; and
a controller configured to:
recognize a driving lane, based on an image captured by the camera,
determine an expected lane width of the driving lane over time,
determine whether a real lane width of the driving lane increases at a time point at which the determined expected lane width increases, and
control driving, based on information on a line, when it is determined that the real lane width increases, wherein the line is one among two lines of the driving lane and positioned opposite a side of the driving lane in which the lane width increases.

12. The vehicle control system of claim 11, wherein the camera is configured to collect image information obtained by capturing the image of the foreground of the vehicle, and
the controller is further configured to recognize the driving lane in the image information, and determine an expected lane width of the driving lane, based on information related to the recognized driving lane.

13. The vehicle control system of claim 12, wherein the controller is configured to determine an expected lane width of a driving lane recognized by the camera, based on a longitudinal distance of the vehicle and at least one information among an offset, a heading angle, a curvature, and a curvature derivative value of the line.

14. The vehicle control system of claim 11, wherein the controller is further configured to:
determine a real lane width of the driving lane at a time point at which the expected lane width increases, and
determine whether the determined real lane width increases within a pre-configured reference time from the time point.

15. The vehicle control system of claim 11, wherein the controller is further configured to:
determine an increased amount of the expected lane width in a time interval in which the expected lane width increases,
determine a changed amount of the real lane width of the driving lane in the time interval, and
determine whether the real lane width increases, based on the changed amount of the real lane width and the increased amount of the expected lane width.

16. The vehicle control system of claim 11, wherein the controller is further configured to determine that the vehicle has entered a stretch in which the driving lane includes at least one lane among a diverged lane and an expanded lane, when it is determined that the real lane width increases.

17. The vehicle control system of claim 16, wherein the controller is further configured to, when the vehicle enters the stretch, generate driving control information of the vehicle, based on information of the line, and reflect a pre-configured correction value on the generated driving control information and output the driving control information.

18. The vehicle control system of claim 17, wherein the controller is configured to, when the vehicle enters the stretch, generate driving control information of the vehicle, based on at least one information among an offset, a heading angle, a curvature, and a curvature derivative value of the line.

19. The vehicle control system of claim 11, wherein the controller is further configured to:
determine whether the driving lane is an outermost lane when it is determined that the real lane width increases, and
determine that the vehicle has entered a stretch in which the driving lane includes at least one lane among a diverged lane and an expanded lane when the driving lane is the outermost lane.

20. The vehicle control system of claim 19, wherein the controller is further configured to, when it is determined that the real lane width increases, collect at least one piece of information among information on the two lines of the driving lane, and information relating to existence or absence of a road edge with respect to both sides of the driving lane, and determine whether the driving lane is an outermost lane, by using the collected at least one piece of information.
